(19) United States
(12) Patent Application Publication
(10) Pub. No.: US 2026/0106554 A1
(43) Pub. Date: Apr. 16, 2026

(54) BIDIRECTIONAL CHARGER

(71) Applicant: KABUSHIKI KAISHA TOYOTA JIDOSHOKKI, Aichi-ken (JP)

(72) Inventor: Takahiro SUZUKI, Kariya-shi (JP)

(73) Assignee: KABUSHIKI KAISHA TOYOTA JIDOSHOKKI, Aichi-ken (JP)

(21) Appl. No.: 19/179,439

(22) Filed: Apr. 15, 2025

(30) Foreign Application Priority Data
Apr. 23, 2024 (JP) 2024-069448

(51) Int. Cl. H02M 3/335; H02J 7/00; H02M 7/797; B60L 53/22

(52) U.S. Cl. CPC H02M 3/33584; H02J 7/865; H02M 3/33573; H02M 7/797; B60L 53/22; B60L 2210/10; H02J 2207/20

(57) ABSTRACT

In a bidirectional charger that can perform the charging of a battery or single-phase three-wire power supplying, noise input to a commercial power supply side in charging the battery is reduced. A bidirectional charger includes: a first bidirectional power conversion circuit that converts DC power from a battery into AC power, and outputs the AC power via a hot-side first input/output terminal and a neutral terminal to a first load in single-phase three-wire power supplying; and a second bidirectional power conversion circuit that converts DC power from the battery into AC power, and outputs the AC power via a second input/output terminal and the neutral terminal to a second load in single-phase three-wire power supplying, and each of the first and second bidirectional power conversion circuits incudes a totem-pole bidirectional inverter circuit that only includes an inductor in some arms of plural arms, and a bidirectional DCDC converter circuit.

### CROSS-REFERENCE TO RELATED APPLICATION

This application is based upon and claims the benefit of priority to Japanese Patent Application No. 2024-069448, filed on April 23, 2024, the entire contents of which are incorporated herein by reference.

### FIELD

The present invention relates to a bidirectional charger.

### BACKGROUND

A bidirectional charger that includes two bidirectional power conversion circuits is available. At the time of charging a battery, each of the bidirectional power conversion circuits converts AC power that has been supplied from a commercial power supply via a hot-side voltage line and a cold-side voltage line into DC power, and outputs the DC power to the battery. At the time of supplying power in a single-phase three-wire system, one bidirectional power conversion circuit converts DC power that has been supplied from the battery into AC power, and outputs the AC power via the hot-side voltage line and a ground-side neutral line to one load, and another bidirectional power conversion circuit converts DC power that has been supplied from the battery into AC power, and outputs the AC power via the cold-side voltage line and the neutral line to another load. An example of a related technology is JP 2002-78350 A.

Meanwhile, in a case where a bidirectional inverter circuit and a bidirectional DCDC converter circuit are included as the bidirectional power conversion circuit, and in a case where each arm of the bidirectional inverter circuit includes an inductor, there is a possibility that noise will occur in each of the inductors due to switching of a switching element in the bidirectional inverter circuit.

In the bidirectional charger described above, in a case where respective bidirectional inverter circuits of the bidirectional power conversion circuits include an inductor on each of the arms, the inductor is connected to each of the hot-side voltage line, the cold-side voltage line, and the neutral line. If a power-factor improvement operation is performed at the time of a charging operation, a switching element side potential of each of the inductors varies when the switching element performs switching, and therefore there is a possibility that relatively large noise will be generated, and the noise will be input to a side of the commercial power supply at the time of charging the battery.

### SUMMARY

It is an object in one aspect of the present invention to reduce noise to be input to a side of a commercial power supply at the time of charging a battery in a bidirectional charger that can charge the battery or can supply power in the single-phase three-wire system.

A bidirectional charger according to an embodiment of the present invention includes: a first input/output terminal that is connected to a first load; a second input/output terminal that is connected to a second load that is connected in series to the first load; a neutral terminal that is connected to a connection point between the first load and the second load, and is grounded; a first switch; a second switch; a first bidirectional inverter circuit that is connected to the first input/output terminal and one end of the first switch; a second bidirectional inverter circuit that is connected to the second input/output terminal and one end of the second switch; a first bidirectional DCDC converter circuit that converts DC power that has been supplied from the first bidirectional inverter circuit into DC power having a different voltage to output the DC power after conversion to a battery, and converts DC power that has been supplied from the battery into DC power having a different voltage to output the DC power after conversion to the first bidirectional inverter circuit; a second bidirectional DCDC converter circuit that converts DC power that has been supplied from the second bidirectional inverter circuit into DC power having a different voltage to output the DC power after conversion to the battery, and converts DC power that has been supplied from the battery into DC power having a different voltage to output the DC power after conversion to the second bidirectional inverter circuit; and a control unit that controls the first bidirectional inverter circuit, the second bidirectional inverter circuit, the first bidirectional DCDC converter circuit, the second bidirectional DCDC converter circuit, the first switch, and the second switch, another end of the first switch is switchably connected to the neutral terminal and the second input/output terminal, another end of the second switch is switchably connected to the neutral terminal and the first input/output terminal, the first bidirectional inverter circuit includes: a first arm to which a first switching element and a second switching element are connected in series; a second arm to which a third switching element and a fourth switching element are connected in series; and a first coil in which one end is connected to a connection point between the first switching element and the second switching element, and another end is connected to one of the first input/output terminal and the one end of the first switch, the first arm and the second arm are connected in parallel, and a connection point between the third switching element and the fourth switching element is connected to another of the first input/output terminal and the one end of the first switch, the second bidirectional inverter circuit includes; a third arm to which a fifth switching element and a sixth switching element are connected in series; a fourth arm to which a seventh switching element and an eighth switching element are connected in series; and a second coil in which one end is connected to a connection point between the fifth switching element and the sixth switching element, and another end is connected to one of the second input/output terminal and the one end of the second switch, and the third arm and the fourth arm are connected in parallel, and a connection point between the seventh switching element and the eighth switching element is connected to another of the second input/output terminal and the one end of the second switch.

By doing this, respective bidirectional inverter circuits included in the first and second bidirectional power conversion circuits can be configured as totem-pole bidirectional inverter circuits, and therefore the number of inductors that are connected to a hot-side voltage line, a cold-side voltage line, and a neutral line can be reduced. Therefore, at the time of charging the battery, noise that occurs in each of the inductors due to switching of the switching elements in the bidirectional inverter circuit can be reduced, and noise that is input to the side of the commercial power supply can be reduced at the time of charging the battery.

Furthermore, the control unit may be configured to perform control to cause the first coil of the first bidirectional inverter circuit to be connected to the first input/output terminal, and cause the second coil of the second bidirectional inverter circuit to be connected to the neutral terminal at the time of supplying power in the single-phase three-wire system.

The control unit may also be configured to perform control to cause the first coil of the first bidirectional inverter circuit to be connected to the neutral terminal, and cause the second coil of the second bidirectional inverter circuit to be connected to the neutral terminal at the time of supplying power in the single-phase three-wire system.

The control unit may also be configured to perform control to cause the first coil of the first bidirectional inverter circuit to be connected to the first input/output terminal, and cause the second coil of the second bidirectional inverter circuit to be connected to the second input/output terminal at the time of supplying power in the single-phase three-wire system.

Moreover, the first bidirectional inverter circuit may include a fifth arm and a third coil, the fifth arm being connected in parallel to the first arm and the second arm, a ninth switching element and a tenth switching element being connected in series to the fifth arm, in the third coil, one end may be connected to a connection point between the ninth switching element and the tenth switching element, and another end may be connected to one of the first input/output terminal and the one end of the first switch, the second bidirectional inverter circuit may include a sixth arm and a fourth coil, the sixth arm being connected in parallel to the third arm and the fourth arm, an eleventh switching element and a twelfth switching element being connected in series to the sixth arm, and in the fourth coil, one end may be connected to a connection point between the eleventh switching element and the twelfth switching element, and another end may be connected to one of the second input/output terminal and the one end of the second switch.

By doing this, the bidirectional inverter circuit can be constituted by an interleaved bidirectional inverter circuit, and therefore the number of arms of the bidirectional inverter circuit can be increased. Therefore, power to be output to a side of the battery at the time of charging the battery or power to be output to a side of the load at the time of supplying power in the single-phase three-wire system can be increased.

### BRIEF DESCRIPTION OF DRAWINGS

FIG. 1 is a diagram illustrating an example of a bidirectional charger according to an embodiment;

FIG. 2 is a diagram illustrating an example of a bidirectional DCDC converter circuit;

FIG. 3 is a diagram illustrating a first variation of the bidirectional charger according to the embodiment;

FIG. 4 is a diagram illustrating a second variation of the bidirectional charger according to the embodiment; and

FIG. 5 is a diagram illustrating a third variation of the bidirectional charger according to the embodiment.

### DESCRIPTION OF EMBODIMENTS

Embodiments will be described below in detail with reference to the drawings.

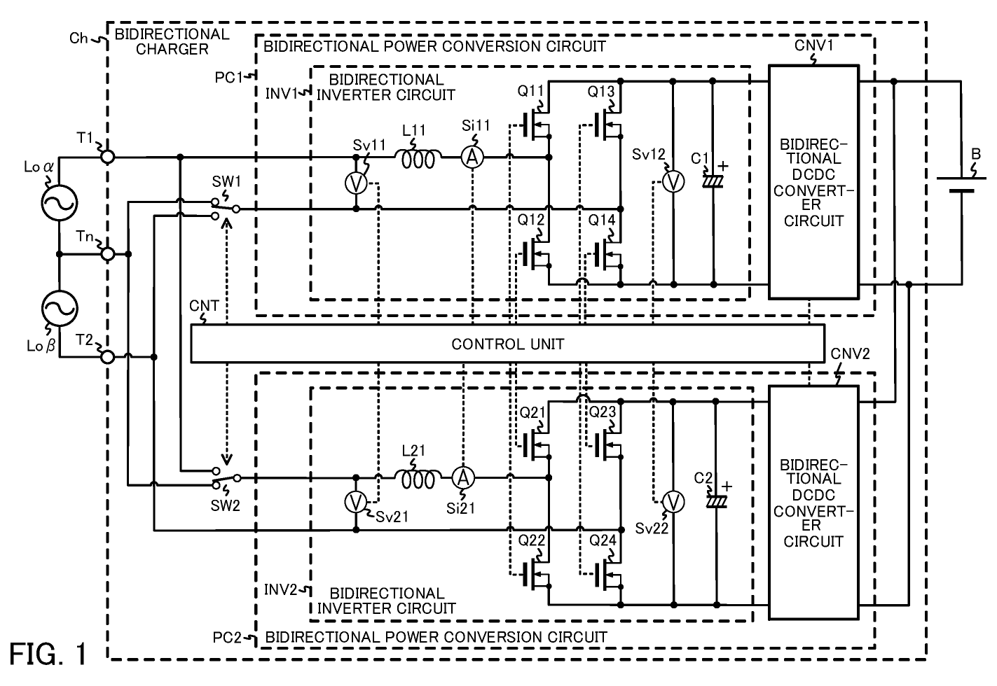

FIG. 1 is a diagram illustrating an example of a bidirectional charger according to an embodiment.

A bidirectional charger Ch illustrated in FIG. 1 is mounted on a vehicle such as an electric vehicle or a plug-in hybrid vehicle, and has a function of converting AC power that has been supplied from a commercial power supply into DC power, and outputting the DC power to a battery B mounted on the vehicle to charge the battery B, and a function of converting DC power that has been supplied from the battery B into AC power, and supplying the AC power to a load such as an electrical product by using a single-phase three-wire system to drive the load.

Furthermore, the bidirectional charger Ch includes an input/output terminal T1 (a first input/output terminal) that is connected to a load Loα (a first load), an input/output terminal T2 (a second input/output terminal) that is connected to a load Loβ (a second load) that is connected in series to the load Loα, and a neutral terminal Tn that is connected to a connection point between the load Loα and the load Loβ, and is grounded. Furthermore, the load Loα and the load Loβ may be directly connected to the input/output terminal T1, the input/output terminal T2, and the neutral terminal Tn, or may be connected via a wiring line to the input/output terminal T1, the input/output terminal T2, and the neutral terminal Tn. It is assumed that the loads Loα and Loβ are electrical products that operate at AC 100 V, or the like. It is assumed that the current consumption of the load Loα is Iα, and the current consumption of the load Loβ is Iβ. Accordingly, power consumption at a time when the current consumption Iα has flowed through the load Loα at AC 100 V is power consumption α, and power consumption at a time when the current consumption Iβ has flowed through the load Loβ at AC 100 V is power consumption β. The power consumption α and the power consumption β are not necessarily constant, and the power consumption α and the power consumption β can change according to a change in current consumption. The power consumption α and the power consumption β may have the same value, the power consumption α may be greater than the power consumption β, or the power consumption α may be smaller than the power consumption β. In a case where the loads Loα and Loβ are not distinguished from each other, they are simply referred to as loads Lo.

Note that it is assumed that at the time of charging the battery B, power is supplied to the bidirectional charger Ch from a not-illustrated commercial power supply that is connected between the input/output terminal T1 on a hot side and the input/output terminal T2 on a cold side.

Furthermore, it is assumed that the battery B is a chargeable/dischargeable battery such as a lithium-ion secondary battery, and is, for example, a chargeable/dischargeable battery for supplying power to a driving device such as a travelling motor, or a chargeable/dischargeable battery for supplying power to electric equipment such as an air compressor or a vehicle-side control unit that controls the driving of a vehicle.

Furthermore, the bidirectional charger Ch includes a changeover switch SW1 (a first switch), a changeover switch SW2 (a second switch), a bidirectional power conversion circuit PC1 (a first bidirectional power conversion circuit), a bidirectional power conversion circuit PC2 (a second bidirectional power conversion circuit), and a control unit CNT.

At the time of charging the battery B, the changeover switches SW1 and SW2 cause each of the bidirectional power conversion circuit PC1 and the bidirectional power conversion circuit PC2 to be connected between the input/output terminal T1 and the input/output terminal T2. Furthermore, at the time of charging the battery B, a commercial power supply is connected between the input/output terminal T1 and the input/output terminal T2. Therefore, at the time of charging the battery B, power can be supplied from the commercial power supply via the bidirectional power conversion circuit PC1 and the bidirectional power conversion circuit PC2 to the battery B. By doing this, at the time of charging the battery B, power to be supplied to the battery B can be increased in comparison with a case where power is supplied from the commercial power supply via only a single bidirectional power conversion circuit to the battery B, and this can reduce the charging time of the battery B.

Furthermore, at the time of supplying power in the single-phase three-wire system, the changeover switches SW1 and SW2 cause the bidirectional power conversion circuit PC1 to be connected between the input/output terminal T1 and the neutral terminal Tn, and cause the bidirectional power conversion circuit PC2 to be connected between the input/output terminal T2 and the neutral terminal Tn.

### <Configurations of Bidirectional Power Conversion Circuits PC1 and PC2>

The bidirectional power conversion circuit PC1 includes a bidirectional inverter circuit INV1 (a first bidirectional inverter circuit) and a bidirectional DCDC converter circuit CNV1 (a first bidirectional DCDC converter circuit), and the bidirectional power conversion circuit PC2 includes the bidirectional inverter circuit INV2 (a second bidirectional inverter circuit) and the bidirectional DCDC converter circuit CNV2 (a second bidirectional DCDC converter circuit). In a case where the bidirectional inverter circuits INV1 and INV2 are not distinguished from each other, they are simply referred to as bidirectional inverter circuits INV, and in a case where the bidirectional DCDC converter circuits CNV1 and CNV2 are not distinguished from each other, they are simply referred to as bidirectional DCDC converter circuits CNV.

### <Example of Operations of Bidirectional Inverter Circuits INV1 and INV2 and Bidirectional DCDC Converter Circuits CNV1 and CNV2 at the Time of Charging Battery B>

At the time of charging the battery B, the bidirectional inverter circuit INV1 converts AC power that has been supplied from the commercial power supply into DC power, and outputs the DC power to the bidirectional DCDC converter circuit CNV1, and the bidirectional DCDC converter circuit CNV1 converts the DC power that has been output from the bidirectional inverter circuit INV1 into DC power having a different voltage, and outputs the DC power to the battery B. Furthermore, at the time of charging the battery B, the bidirectional inverter circuit INV2 converts AC power that has been supplied from the commercial power supply into DC power, and outputs the DC power to the bidirectional DCDC converter circuit CNV2, and the bidirectional DCDC converter circuit CNV2 converts the DC power that has been output from the bidirectional inverter circuit INV2 into DC power having a different voltage, and outputs the DC power to the battery B. Stated another way, at the time of charging the battery B, each of the bidirectional power conversion circuits PC1 and PC2 converts AC power that has been supplied from the commercial power supply via the input/output terminal T1 and the input/output terminal T2 into DC power, and outputs the DC power to the battery B.

### <Example of Operations of Bidirectional Inverter Circuits INV1 and INV2 and Bidirectional DCDC Converter Circuits CNV1 and CNV2 at the Time of Supplying Power in Single-Phase Three-Wire System>

The bidirectional power conversion circuit PC1 is controlled in such a way that AC 100 V is applied between the input/output terminal T1 and the neutral terminal Tn, and the bidirectional power conversion circuit PC2 is controlled in such a way that AC 100 V is applied between the input/output terminal T2 and the neutral terminal Tn. As described above, it is assumed that each of the loads Loα and Loβ is equipment that operates at AC 100 V, the current consumption of the load Loα is Iα, and the current consumption of the load Loβ is Iβ. Accordingly, power consumption at a time when the current consumption Iα has flowed through the load Loα at AC 100 V is power consumption α, and power consumption at a time when the current consumption Iβ has flowed through the load Loβ at AC 100 V is power consumption β.

At the time of supplying power in the single-phase three-wire system, in a case where the load Loα is only connected between the input/output terminal T1 and the neutral terminal Tn, the bidirectional DCDC converter circuit CNV1 converts DC power that has been supplied from the battery B into DC power having a different voltage, and outputs the DC power to the bidirectional inverter circuit INV1, and the bidirectional inverter circuit INV1 controls the DC power that has been output from the bidirectional DCDC converter circuit CNV1 in such a way that the current consumption Iα flows at AC 100 V. Stated another way, the bidirectional power conversion circuit PC1 performs conversion into AC power that corresponds to the power consumption α of the load Loα, and outputs the AC power via the input/output terminal T1 and the neutral terminal Tn to the load Loα. This can drive the load Loα. Note that the bidirectional power conversion circuit PC2 generates AC 100 V between the neutral terminal Tn and the input/output terminal T2, but a current does not flow.

Furthermore, at the time of supplying power in the single-phase three-wire system, in a case where the load Loβ is only connected between the input/output terminal T2 and the neutral terminal Tn, the bidirectional DCDC converter circuit CNV2 converts the DC power that has been supplied from the battery B into DC power having a different voltage, and outputs the DC power to the bidirectional inverter circuit INV2, and the bidirectional inverter circuit INV2 controls the DC power that has been output from the bidirectional DCDC converter circuit CNV2 in such a way that current consumption Iβ flows at AC 100 V. Stated another way, the bidirectional power conversion circuit PC2 performs conversion into AC power that corresponds to the power consumption β of the load Loβ, and outputs the AC power via the input/output terminal T2 and the neutral terminal Tn to the load Loβ. This can drive the load Loβ. Note that the bidirectional power conversion circuit PC1 generates AC 100 V between the input/output terminal T1 and the neutral terminal Tn, but a current does not flow.

At the time of supplying power in the single-phase three-wire system, in a case where the load Loα is connected between the input/output terminal T1 and the neutral terminal Tn, and the load Loβ is connected between the input/output terminal T2 and the neutral terminal Tn, the bidirectional DCDC converter circuit CNV1 converts DC power that has been supplied from the battery B into DC power having a different voltage, and outputs the DC power to the bidirectional inverter circuit INV1, and the bidirectional inverter circuit INV1 controls the DC power that has been output from the bidirectional DCDC converter circuit CNV1 in such a way that the current consumption Iα flows at AC 100 V. Stated another way, the bidirectional power conversion circuit PC1 converts the DC power that has been supplied from the battery B into AC power that corresponds to the power consumption α, and outputs the AC power to the load Loα. Furthermore, the bidirectional DCDC converter circuit CNV2 converts DC power that has been supplied from the battery B into DC power having a different voltage, and outputs the DC power to the bidirectional inverter circuit INV2, and the bidirectional inverter circuit INV2 controls the DC power that has been output from the bidirectional DCDC converter circuit CNV2 in such a way that the current consumption Iβ flows at AC 100 V. Stated another way, the bidirectional power conversion circuit PC2 converts the DC power that has been supplied from the battery B into AC power that corresponds to the power consumption β, and outputs the AC power to the load Loβ. This can simultaneously drive the load Loα and the load Loβ.

### <Configuration of Bidirectional Inverter Circuit INV1>

The bidirectional inverter circuit INV1 is a totem-pole bidirectional inverter circuit in which only one arm of two arms includes an inductor, and includes an inductor L11 (a first coil), a switching element Q11 (a first switching element), a switching element Q12 (a second switching element), a switching element Q13 (a third switching element), a switching element Q14 (a fourth switching element), a capacitor C1, voltage sensors Sv11 and Sv12, and a current sensor Si11. For example, the switching elements Q11 to Q14 are constituted by a metal oxide semiconductor field effect transistor (MOSFET). Note that the switching elements Q11 and Q12 constitute a first arm, and the switching elements Q13 and Q14 constitute a second arm.

One end of the inductor L11 is connected to the input/output terminal T1, and another end of the inductor L11 is connected to a connection point between a source terminal of the switching element Q11 and a drain terminal of the switching element Q12. A connection point between a source terminal of the switching element Q13 and a drain terminal of the switching element Q14 is connected via the changeover switch SW1 to the input/output terminal T2 and the neutral terminal Tn. Respective drain terminals of the switching elements Q11 and Q13 are connected to each other, and are connected to one end of the capacitor C1. Respective source terminals of the switching elements Q12 and Q14 are connected to each other, and are connected to another end of the capacitor C1.

The voltage sensor Sv11 detects a voltage applied between the input/output terminal T1 and the input/output terminal T2 at the time of charging the battery B, detects a voltage applied between the input/output terminal T1 and the neutral terminal Tn at the time of supplying power in the single-phase three-wire system, and transmits the detected voltages to the control unit CNT.

The voltage sensor Sv12 detects a voltage applied to the capacitor C1 at the time of charging the battery B or at the time of supplying power in the single-phase three-wire system, and transmits the detected voltage to the control unit CNT.

The current sensor Si11 detects a current that flows through the inductor L11 at the time of charging the battery B or at the time of supplying power in the single-phase three-wire system, and transmits the detected current to the control unit CNT.

### <Configuration of Bidirectional Inverter Circuit INV2>

The bidirectional inverter circuit INV2 is a totem-pole bidirectional inverter circuit in which only one arm of two arms includes an inductor, similarly to the bidirectional inverter circuit INV1, and includes an inductor L21 (a second coil), a switching element Q21 (a fifth switching element), a switching element Q22 (a sixth switching element), a switching element Q23 (a seventh switching element), a switching element Q24 (an eighth switching element), a capacitor C2, voltage sensors Sv21 and Sv22, and a current sensor Si21. For example, the switching elements Q21 to Q24 are constituted by a MOSFET. In a case where the inductors L11 and L21 are not distinguished from each other, they are simply referred to as inductors L. Furthermore, in a case where the switching elements Q11 to Q14 and Q21 to Q24 are not distinguished from each other, they are simply referred to as switching elements Q. Moreover, the switching elements Q21 and Q22 constitute a third arm, and the switching elements Q23 and Q24 constitute a fourth arm.

One end of the inductor L21 is connected via the changeover switch SW2 to the input/output terminal T1 and the neutral terminal Tn. A connection point between a source terminal of the switching element Q21 and a drain terminal of the switching element Q22 is connected to another end of the inductor L21. A connection point between a source terminal of the switching element Q23 and a drain terminal of the switching element Q24 is connected to the input/output terminal T2. Respective drain terminals of the switching elements Q21 and Q23 are connected to each other, and are connected to one end of the capacitor C2. Respective source terminals of the switching elements Q22 and Q24 are connected to each other, and are connected to another end of the capacitor C2.

The voltage sensor Sv21 detects a voltage applied between the input/output terminal T1 and the input/output terminal T2 at the time of charging the battery B, detects a voltage applied between the input/output terminal T2 and the neutral terminal Tn at the time of supplying power in the single-phase three-wire system, and transmits the detected voltages to the control unit CNT.

The voltage sensor Sv22 detects a voltage applied to the capacitor C2 at the time of charging the battery B or at the time of supplying power in the single-phase three-wire system, and transmits the detected voltage to the control unit CNT.

The current sensor Si21 detects a current that flows through the inductor L21 at the time of charging the battery B or at the time of supplying power in the single-phase three-wire system, and transmits the detected current to the control unit CNT.

As described above, the respective bidirectional inverter circuits INV included in the bidirectional power conversion circuits PC1 and PC2 are totem-pole bidirectional inverter circuits, the number of inductors L that are connected to the input/output terminal T1, the input/output terminal T2, and the neutral terminal Tn can be reduced, and the number of switching elements that are connected to the inductor L can also be reduced. This can reduce the number of places where a variation in a potential on a switching element side of the inductor L occurs when the switching element performs switching in the power-factor improvement operation at the time of charging. Therefore, at the time of charging the battery B, noise that occurs due to switching of the switching element Q in the bidirectional inverter circuit INV can be reduced, and noise that is input to a side of the commercial power supply can be reduced at the time of charging the battery B.

### <Configuration of Control Unit CNT>

The control unit CNT is constituted by, for example, a processor or a programmable device (a field programmable gate array (FPGA), a programmable logic device (PLD), or the like), and controls respective operations of the changeover switches SW1 and SW2 and the bidirectional power conversion circuits PC1 and PC2. Note that the control unit CNT may be constituted by a plurality of control units, such as a control unit that controls operations of the changeover switches SW1 and SW2, a control unit that controls an operation of the bidirectional power conversion circuit PC1, and a control unit that controls an operation of the bidirectional power conversion circuit PC2.

### <Example of Control on Operation of Bidirectional Inverter Circuit INV1 at the Time of Charging Battery B>

In a case where a current that has been detected by the current sensor Si11 is positive (in a case where a current flows from the input/output terminal T1 via the inductor L11 to the switching elements Q11 and Q12), the control unit CNT repeats an operation to turn on the switching element Q12, and turn off the switching element Q11, and then turn off the switching element Q12, and turn on the switching element Q11, while maintaining the switching element Q14 in an ON state at all times, and maintaining the switching element Q13 in an OFF state at all times. Furthermore, in a case where the current that has been detected by the current sensor Si11 is negative (in a case where a current flows from the switching elements Q11 and Q12 via the inductor L11 to the input/output terminal T1), the control unit CNT repeats an operation to turn on the switching element Q11, and turn off the switching element Q12, and then turn off the switching element Q11, and turn on the switching element Q12, while maintaining the switching element Q13 in the ON state at all times, and maintaining the switching element Q14 in the OFF state at all times. By doing this, at the time of charging the battery B, AC power that has been input from the commercial power supply via the input/output terminal T1 and the input/output terminal T2 to the bidirectional inverter circuit INV1 is improved in the power factor, and is rectified, and the rectified power is smoothed by the capacitor C1, and is output to the bidirectional DCDC converter circuit CNV1.

### <Example of Control on Operation of Bidirectional Inverter Circuit INV2 at the Time of Charging Battery B>

In a case where a current that has been detected by the current sensor Si21 is positive (in a case where a current flows from the input/output terminal T1 via the inductor L21 to the switching elements Q21 and Q22), the control unit CNT repeats an operation to turn on the switching element Q22, and turn off the switching element Q21, and then turn off the switching element Q22, and turn on the switching element Q21, while maintaining the switching element Q24 in the ON state at all times, and maintaining the switching element Q23 in the OFF state at all times. Furthermore, in a case where the current that has been detected by the current sensor Si21 is negative (in a case where a current flows from the switching elements Q21 and Q22 via the inductor L21 to the input/output terminal T1), the control unit CNT repeats an operation to turn on the switching element Q21, and turn off the switching element Q22, and then turn off the switching element Q21, and turn on the switching element Q22, while maintaining the switching element Q23 in the ON state at all times, and maintaining the switching element Q24 in the OFF state at all times. By doing this, at the time of charging the battery B, AC power that has been input from the commercial power supply via the input/output terminal T1 and the input/output terminal T2 to the bidirectional inverter circuit INV2 is improved in the power factor, and is rectified, and the rectified power is smoothed by the capacitor C2, and is output to the bidirectional DCDC converter circuit CNV2.

### <Example of Control on Operation of Bidirectional Inverter Circuit INV1 at the Time of Supplying Power in Single-Phase Three-Wire System>

The control unit CNT repeats an operation to turn on the switching elements Q11 and Q14, and turn off the switching elements Q12 and Q13, and then turn off the switching elements Q11 and Q14, and turn on the switching elements Q12 and Q13. By doing this, DC power that has been input from the bidirectional DCDC converter circuit CNV1 via the capacitor C1 to the bidirectional inverter circuit INV1 is converted into AC power by the bidirectional inverter circuit INV1, and the AC power is supplied to the load Loα that is connected between the input/output terminal T1 and the neutral terminal Tn.

Note that a switching element that is turned on or off only at the time of polarity inversion may be included. For example, during a period when a positive voltage is applied to the input/output terminal T1, the switching element Q11 may be repeatedly turned on or off while maintaining the switching element Q14 in the ON state at all times, and maintaining the switching elements Q12 and Q13 in the OFF state at all times, and during a period when a negative voltage is applied to the input/output terminal T1, the switching element Q12 may be repeatedly turned on or off while maintaining the switching element Q13 in the ON state at all times, and maintaining the switching elements Q11 and Q14 in the OFF state at all times.

### <Example of Control on Operation of Bidirectional Inverter Circuit INV2 at the Time of Supplying Power in Single-Phase Three-Wire System>

The control unit CNT repeats an operation to turn on the switching elements Q21 and Q24, and turn off the switching elements Q22 and Q23, and then turn off the switching elements Q21 and Q24, and turn on the switching elements Q22 and Q23. By doing this, DC power that has been input from the bidirectional DCDC converter circuit CNV2 via the capacitor C2 to the bidirectional inverter circuit INV2 is converted into AC power by the bidirectional inverter circuit INV2, and the AC power is supplied to the load Loβ that is connected between the input/output terminal T2 and the neutral terminal Tn.

Note that a switching element that is turned on or off only at the time of polarity inversion may be included. For example, during a period when a positive voltage is applied to the neutral terminal Tn, the switching element Q21 may be repeatedly turned on or off while maintaining the switching element Q24 in the ON state at all times, and maintaining the switching elements Q22 and Q23 in the OFF state at all times, and during a period when a negative voltage is applied to the neutral terminal Tn, the switching element Q22 may be repeatedly turned on or off while maintaining the switching element Q23 in the ON state at all times, and maintaining the switching elements Q21 and Q24 in the OFF state at all times.

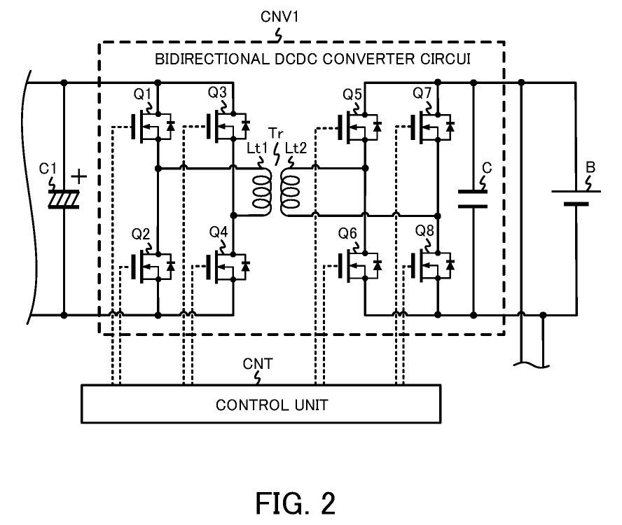

FIG. 2 is a diagram illustrating a circuit example of the bidirectional DCDC converter circuit CNV1. Note that a circuit example of the bidirectional DCDC converter circuit CNV2 may be similar to the circuit example of the bidirectional DCDC converter circuit CNV1 illustrated in FIG. 2.

The bidirectional DCDC converter circuit CNV1 illustrated in FIG. 2 includes a transformer Tr, switching elements Q1 to Q4 that constitute a primary bridge circuit of the transformer Tr, switching elements Q5 to Q8 that constitute a secondary bridge circuit of the transformer Tr, and a capacitor C. Note that the switching elements Q1 to Q8 are constituted by, for example, a MOSFET.

Respective drain terminals of the switching elements Q1 and Q3 are connected to one end of the capacitor C1, and respective source terminals of the switching elements Q2 and Q4 are connected to another end of the capacitor C1. A connection point between a source terminal of the switching element Q1 and a drain terminal of the switching element Q2 is connected to one end of a primary coil Lt1 of the transformer Tr, and a connection point between a source terminal of the switching element Q3 and a drain terminal of the switching element Q4 is connected to another end of the primary coil Lt1. Respective drain terminals of the switching elements Q5 and Q7 are connected to one end of the capacitor C and a positive electrode terminal of the battery B, and respective source terminals of the switching elements Q6 and Q8 are connected to another end of the capacitor C and a negative electrode terminal of the battery B. A connection point between a source terminal of the switching element Q5 and a drain terminal of the switching element Q6 is connected to one end of a secondary coil Lt2 of the transformer Tr, and a connection point between a source terminal of the switching element Q7 and a drain terminal of the switching element Q8 is connected to another end of the secondary coil Lt2.

Note that a circuit example of the bidirectional DCDC converter circuit CNV1 is not limited to the circuit example illustrated in FIG. 2, if it is possible to convert DC power that has been output from the bidirectional inverter circuit INV1 into predetermined DC power, and supply the DC power to the battery B at the time of charging the battery B, and to convert DC power that has been output from the battery B into predetermined DC power, and supply the predetermined DC power to the bidirectional inverter circuit INV1 at the time of supplying power in the single-phase three-wire system. The similar is applied to the bidirectional DCDC converter circuit CNV2.

### <Example of Control on Operation of Bidirectional DCDC Converter Circuit CNV1 at the Time of Charging Battery B>

The control unit CNT repeats an operation to turn on the switching elements Q1 and Q4, and turn off the switching elements Q2 and Q3, and then turn off the switching elements Q1 and Q4, and turn on the switching elements Q2 and Q3, causes the primary coil Lt1 to generate AC, and causes the switching elements Q5 to Q8 to synchronously rectify the AC in such a way that power to be output to the battery B follows target power Pt1. Note that the target power Pt1 is set on the basis of, for example, a voltage of the battery B.

### <Example of Control on Operation of Bidirectional DCDC Converter Circuit CNV1 at the Time of Supplying Power in Single-Phase Three-Wire System>

The control unit CNT repeats an operation to turn on the switching elements Q6 and Q7, and turn off the switching elements Q5 and Q8, and then turn off the switching elements Q6 and Q7, and turn on the switching elements Q5 and Q8, causes the secondary coil Lt2 to generate AC, and causes the switching elements Q1 to Q4 to synchronously rectify the AC in such a way that power to be output to the bidirectional inverter circuit INV1 follows target power Pt2. Note that the target power Pt2 is set on the basis of, for example a voltage of the capacitors C1 and C2.

Note that in a case where the bidirectional DCDC converter circuit CNV1 is driven according to the dual active bridge (DAB) scheme, respective duty ratios of driving signals that drive the switching elements Q1 to Q8 may be 50 [%], and a phase of the driving signals of the switching elements Q1 to Q4 and a phase of the driving signals of the switching elements Q5 to Q8 may be shifted from each other in accordance with the target power Pt1 and the target power Pt2.

Furthermore, an example of control on an operation of the bidirectional DCDC converter circuit CNV2 at the time of charging the battery B or at the time of supplying power in the single-phase three-wire system may be similar to the example of control on the operation of the bidirectional DCDC converter circuit CNV1 at the time of charging the battery B or at the time of supplying power in the single-phase three-wire system.

As described above, the bidirectional charger Ch according to the embodiment can reduce noise to be input to a side of the commercial power supply at the time of charging the battery B. This can simplify, for example, a filter (not illustrated) for a reduction in noise that is included in the bidirectional inverter circuits INV1 and INV2.

Furthermore, the bidirectional charger Ch according to the embodiment includes the bidirectional power conversion circuits PC1 and PC2, and this can increase the entire power to be supplied between the input/output terminal T1 and the input/output terminal T2 in comparison with a configuration in which only one bidirectional power conversion circuit is included.

Furthermore, in the bidirectional charger Ch according to the embodiment, at the time of supplying power in the single-phase three-wire system, the capacitor C1 is in charge of feeding power between the input/output terminal T1 and the neutral terminal Tn, and the capacitor C2 is in charge of feeding power between the input/output terminal T2 and the neutral terminal Tn. Power is fed from two independent capacitors, and this causes satisfactory controllability, and resistance to disturbance.

Furthermore, in the bidirectional charger Ch according to the embodiment, for example, in a case where a single CPU is used as the control unit CNT to control the two bidirectional inverter circuits INV1 and INV2, a current flows through the bidirectional inverter circuit INV1 and the bidirectional inverter circuit INV2 in the same direction, and therefore the control unit CNT can easily perform control.

Furthermore, in the bidirectional charger Ch according to the embodiment, at the time of supplying power in the single-phase three-wire system, the bidirectional inverter circuits INV1 and INV2 are directly connected to each other in the neutral terminal Tn, but the connected inductor L21 is interposed, and therefore the inductor can avoid a variation in current, and resonance is not likely to occur in a current loop via respective stray capacitances of the bidirectional inverter circuits INV1 and INV2.

Note that the present invention is not limited to the embodiments described above, and various modifications or alterations can be made without departing from the gist of the present invention.

### <First Variation>

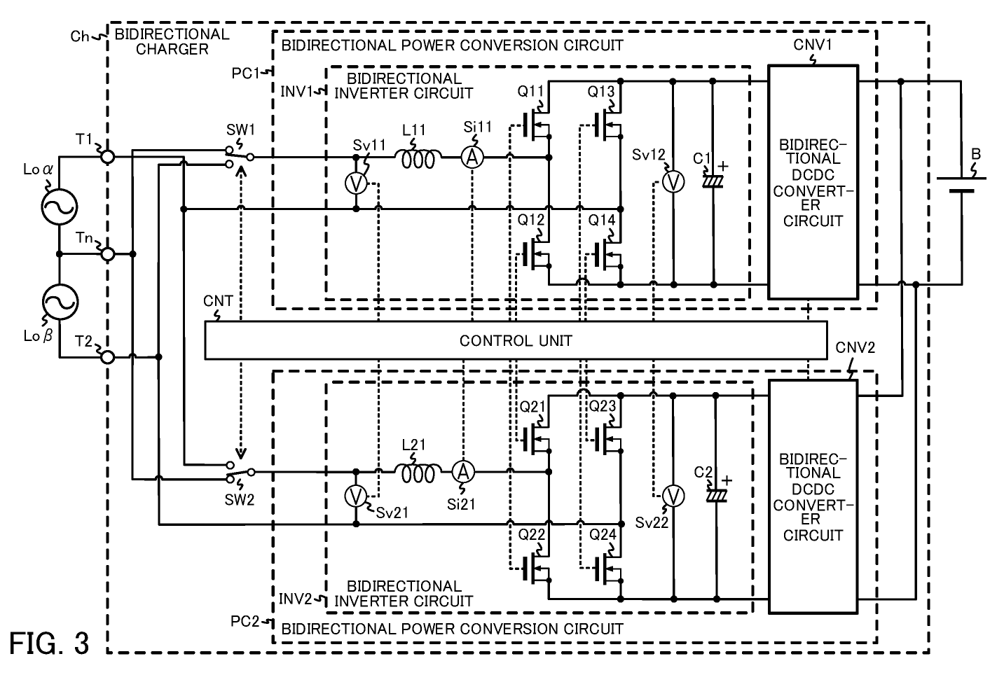

FIG. 3 is a diagram illustrating a first variation of the bidirectional charger Ch according to the embodiment. Note that in FIG. 3, a configuration that is the same as the configuration illustrated in FIG. 1 is denoted by the same reference sign, and the description thereof is omitted.

The bidirectional charger Ch illustrated in FIG. 3 is different from the bidirectional charger Ch illustrated in FIG. 1 in that the changeover switch SW1 is connected to the inductor L11. The changeover switch SW1 according to the first variation connects the inductor L11 to the input/output terminal T2 at the time of charging the battery B, and connects the inductor L11 to the neutral terminal Tn at the time of supplying power in the single-phase three-wire system.

Moreover, in the first variation, the changeover switch SW2 is connected to the inductor L21 similarly to the changeover switch SW2 illustrated in FIG. 1. Stated another way, the changeover switch SW2 according to the first variation connects the inductor L21 to the input/output terminal T1 at the time of charging the battery B, and connects the inductor L21 to the neutral terminal Tn at the time of supplying power in the single-phase three-wire system.

Furthermore, in the first variation, the connection point between the source terminal of the switching element Q13 and the drain terminal of the switching element Q14 is connected to the input/output terminal T1, and the connection point between the source terminal of the switching element Q23 and the drain terminal of the switching element Q24 is connected to the input/output terminal T2.

Therefore, in the bidirectional charger Ch illustrated in FIG. 3, similarly to the bidirectional charger Ch illustrated in FIG. 1, at the time of charging the battery B, each of the bidirectional power conversion circuits PC1 and PC2 is connected between the input/output terminal T1 and the input/output terminal T2, and at the time of supplying power in the single-phase three-wire system, the bidirectional power conversion circuit PC1 is connected between the input/output terminal T1 and the neutral terminal Tn, and the bidirectional power conversion circuit PC2 is connected between the input/output terminal T2 and the neutral terminal Tn.

Stated another way, in the bidirectional charger Ch according to the first variation, at the time of charging the battery B, the inductor L11 is connected to the input/output terminal T2, and the inductor L21 is connected to the input/output terminal T1, and at the time of supplying power in the single-phase three-wire system, each of the inductors L11 and L21 is connected to the neutral terminal Tn.

As described above, in the bidirectional charger Ch illustrated in FIG. 3, similarly to the bidirectional charger Ch illustrated in FIG. 1, respective bidirectional inverter circuits INV included in the bidirectional power conversion circuits PC1 and PC2 are totem-pole bidirectional inverter circuits INV, the number of inductors L that are connected to the input/output terminal T1, the input/output terminal T2, and the neutral terminal Tn can be reduced, and the number of switching elements that are connected to the inductor L can also be reduced. This can reduce the number of places where a variation in a potential on a switching element side of the inductor L occurs when the switching element performs switching in the power-factor improvement operation at the time of charging. Therefore, at the time of charging the battery B, noise that occurs due to switching of the switching element Q in the bidirectional inverter circuit INV can be reduced, and noise that is input to a side of the commercial power supply can be reduced at the time of charging the battery B.

Furthermore, in the bidirectional charger Ch illustrated in FIG. 3, at the time of supplying power in the single-phase three-wire system, the bidirectional inverter circuits INV1 and INV2 are directly connected to each other in the neutral terminal Tn, but the connected inductors L11 and L21 are interposed, and therefore the inductors can avoid a variation in current, and resonance is not likely to occur in a current loop via respective stray capacitances of the bidirectional inverter circuits INV1 and INV2.

Furthermore, in the bidirectional charger Ch illustrated in FIG. 3, at the time of supplying power in the single-phase three-wire system, the connection point between the switching elements Q11 and Q12 and the connection point between the switching elements Q21 and Q22 are connected via the inductors L11 and L21, respectively, and have the same potential as a potential of the neutral terminal Tn, and a voltage at the connection point between the switching elements Q13 and Q14 relative to the neutral terminal Tn and a voltage at the connection point between the switching elements Q23 and Q24 relative to the neutral terminal Tn have phases opposite to each other, and have the same potential difference. From a dynamic point of view, the switching elements Q11 and Q21 and the switching elements Q12 and Q22, which are connected to the inductor L11 or L21, synchronously operate in anti-phase, and the switching elements Q13 and Q23 and the switching elements Q14 and Q24, which are not connected to the inductor, synchronously operate in anti-phase. If the respective bidirectional inverter circuits INV1 and INV2 have roughly the same structure, the stray capacitance of each unit is roughly equal, and therefore a voltage of a path to ground, which is a path through which common mode noise flows, is roughly equal to a voltage of the neutral terminal Tn, a common node noise current can be prevented from occurring, and noise can be reduced.

### <Second Variation>

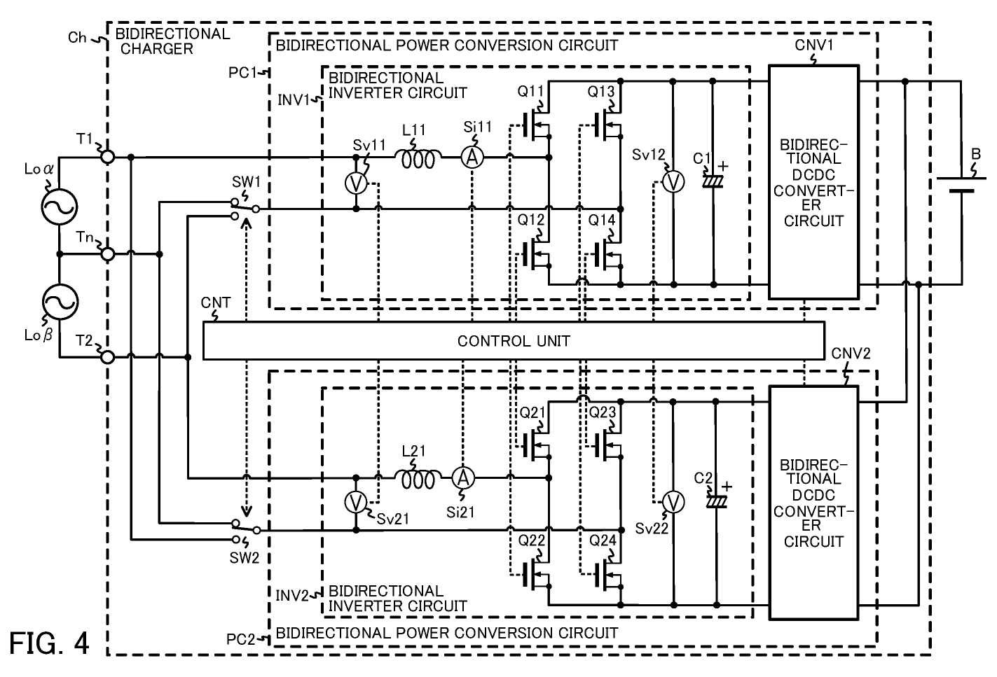

FIG. 4 is a diagram illustrating a second variation of the bidirectional charger Ch according to the embodiment. Note that in FIG. 4, a configuration that is the same as the configuration illustrated in FIG. 1 is denoted by the same reference sign, and the description thereof is omitted.

The bidirectional charger Ch illustrated in FIG. 4 is different from the bidirectional charger Ch illustrated in FIG. 1 in that the changeover switch SW2 is connected to the connection point between the source terminal of the switching element Q23 and the drain terminal of the switching element Q24. At the time of charging the battery B, the changeover switch SW2 according to the second variation connects the connection point between the source terminal of the switching element Q23 and the drain terminal of the switching element Q24 to the input/output terminal T1, and at the time of supplying power in the single-phase three-wire system, the changeover switch SW2 connects the connection point between the source terminal of the switching element Q23 and the drain terminal of the switching element Q24 to the neutral terminal Tn.

Furthermore, in the second variation, the changeover switch SW1 is connected to the connection point between the source terminal of the switching element Q13 and the drain terminal of the switching element Q14, similarly to the changeover switch SW1 illustrated in FIG. 1. Stated another way, at the time of charging the battery B, the changeover switch SW1 according to the second variation connects the connection point between the source terminal of the switching element Q13 and the drain terminal of the switching element Q14 to the input/output terminal T2, and at the time of supplying power in the single-phase three-wire system, the changeover switch SW1 connects the connection point between the source terminal of the switching element Q13 and the drain terminal of the switching element Q14 to the neutral terminal Tn.

Moreover, in the second variation, the inductor L11 is connected to the input/output terminal T1, and the inductor L21 is connected to the input/output terminal T2.

Therefore, in the bidirectional charger Ch illustrated in FIG. 4, similarly to the bidirectional charger Ch illustrated in FIG. 1, at the time of charging the battery B, each of the bidirectional power conversion circuits PC1 and PC2 is connected between the input/output terminal T1 and the input/output terminal T2, and at the time of supplying power in the single-phase three-wire system, the bidirectional power conversion circuit PC1 is connected between the input/output terminal T1 and the neutral terminal Tn, and the bidirectional power conversion circuit PC2 is connected between the input/output terminal T2 and the neutral terminal Tn.

Stated another way, in the bidirectional charger Ch according to the second variation, both at the time of charging the battery B and at the time of supplying power in the single-phase three-wire system, the inductor L11 is connected to the input/output terminal T1, and the inductor L21 is connected to the input/output terminal T2.

As described above, in the bidirectional charger Ch illustrated in FIG. 4, similarly to the bidirectional charger Ch illustrated in FIG. 1, respective bidirectional inverter circuits INV included in the bidirectional power conversion circuits PC1 and PC2 are totem-pole bidirectional inverter circuits INV, the number of inductors L that are connected to the input/output terminal T1, the input/output terminal T2, and the neutral terminal Tn can be reduced, and the number of switching elements that are connected to the inductor L can also be reduced. This can reduce the number of places where a variation in a potential on a switching element side of the inductor L occurs when the switching element performs switching in the power-factor improvement operation at the time of charging. Therefore, at the time of charging the battery B, noise that occurs due to switching of the switching element Q in the bidirectional inverter circuit INV can be reduced, and noise that is input to a side of the commercial power supply can be reduced at the time of charging the battery B.

Furthermore, in the bidirectional charger Ch illustrated in FIG. 4, at the time of supplying power in the single-phase three-wire system, the connection point between the switching elements Q13 and Q14 and the connection point between the switching elements Q23 and Q24 have the same potential as a potential of the neutral terminal Tn, and a voltage at the connection point between the switching elements Q11 and Q12 relative to the neutral terminal Tn and a voltage at the connection point between the switching elements Q21 and Q22 relative to the neutral terminal Tn have phases opposite to each other, and have the same potential difference. From a dynamic point of view, the switching elements Q11 and Q21 and the switching elements Q12 and Q22, which are connected to the inductor L11 or L21, synchronously operate in anti-phase, and the switching elements Q13 and Q23 and the switching elements Q14 and Q24, which are not connected to the inductor, synchronously operate in anti-phase. If the respective bidirectional inverter circuits INV1 and INV2 have roughly the same structure, the stray capacitance of each unit is roughly equal, and therefore a voltage of a path to ground, which is a path through which common mode noise flows, is roughly equal to a voltage of the neutral terminal Tn, a common node noise current can be prevented from occurring, and noise can be reduced.

### <Third Variation>

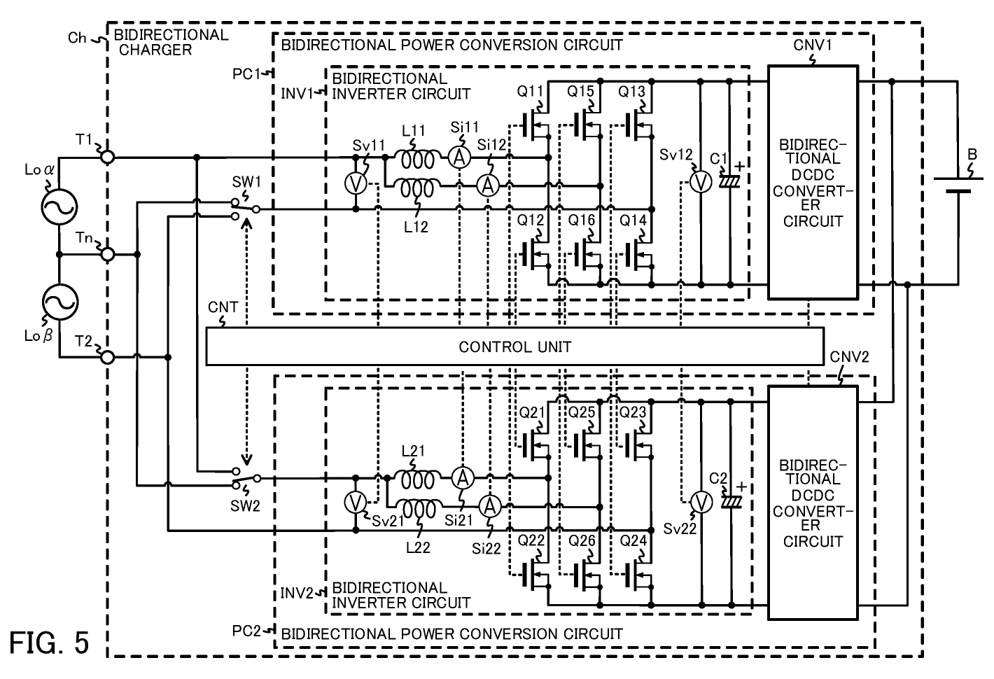

FIG. 5 is a diagram illustrating a third variation of the bidirectional charger Ch according to the embodiment. Note that in FIG. 5, a configuration that is the same as the configuration illustrated in FIG. 1 is denoted by the same reference sign, and the description thereof is omitted.

The bidirectional charger Ch illustrated in FIG. 5 is different from the bidirectional charger Ch illustrated in FIG. 1 in that the respective bidirectional inverter circuits INV1 and INV2 are interleaved bidirectional inverter circuits INV.

The bidirectional inverter circuit INV1 according to the third variation is a totem-pole bidirectional inverter circuit in which only two arms of three arms include an inductor, and includes the inductor L11, an inductor L12 (a third coil), the switching elements Q11 to Q14, a switching element Q15 (a ninth switching element), a switching element Q16 (a tenth switching element), the capacitor C1, the voltage sensors Sv11 and Sv12, and the current sensors Si11 and Si12. Note that the current sensor Si12 detects a current that flows through the inductor L12 at the time of charging the battery B or at the time of supplying power in the single-phase three-wire system, and transmits the detected current to the control unit CNT. Furthermore, the switching elements Q15 and Q16 constitute a fifth arm.

One end of the inductor L11 is connected to the input/output terminal T1 and one end of the inductor L12, and another end of the inductor L11 is connected to the connection point between the source terminal of the switching element Q11 and the drain terminal of the switching element Q12. Another end of the inductor L12 is connected to a connection point between a source terminal of the switching element Q15 and a drain terminal of the switching element Q16. A connection point between a source terminal of the switching element Q13 and a drain terminal of the switching element Q14 is connected via the changeover switch SW1 to the input/output terminal T2 and the neutral terminal Tn. Respective drain terminals of the switching elements Q11, Q13, and Q15 are connected to each other, and are connected to one end of the capacitor C1. Respective source terminals of the switching elements Q12, Q14, and Q16 are connected to each other, and are connected to another end of the capacitor C1.

The bidirectional inverter circuit INV2 according to the third variation is a totem-pole bidirectional inverter circuit in which only two arms of three arms include an inductor, and includes the inductor L21, an inductor L22 (a fourth coil), the switching elements Q21 to Q24, a switching element Q25 (an eleventh switching element), a switching element Q26 (a twelfth switching element), the capacitor C2, the voltage sensors Sv21 and Sv22, and the current sensors Si21 and Si22. Note that the current sensor Si22 detects a current that flows through the inductor L22 at the time of charging the battery B or at the time of supplying power in the single-phase three-wire system, and transmits the detected current to the control unit CNT. Furthermore, the switching elements Q25 and Q26 constitute a sixth arm.

One end of the inductor L21 is connected via the changeover switch SW2 to the input/output terminal T1 and the neutral terminal Tn, and is connected to one end of the inductor L22, and another end of the inductor L21 is connected to the connection point between the source terminal of the switching element Q21 and the drain terminal of the switching element Q22. Another end of the inductor L22 is connected to a connection point between a source terminal of the switching element Q25 and a drain terminal of the switching element Q26. A connection point between a source terminal of the switching element Q23 and a drain terminal of the switching element Q24 is connected to the input/output terminal T2. Respective drain terminals of the switching elements Q21, Q23, and Q25 are connected to each other, and are connected to one end of the capacitor C2. Respective source terminals of the switching elements Q22, Q24, and Q26 are connected to each other, and are connected to another end of the capacitor C2.

### <Example of Control on Operation of Bidirectional Inverter Circuit INV1 at the Time of Charging Battery B>

In a case where currents that have been detected by the current sensors Si11 and Si12 are positive (in a case where a current flows from the commercial power supply via the inductors L11 and L12 to the switching elements Q11, Q12, Q15, and Q16), the control unit CNT repeats an operation to turn on the switching elements Q12 and Q15, and turn off the switching elements Q11 and Q16, and then turn off the switching elements Q12 and Q15, and turn on the switching elements Q11 and Q16, while maintaining the switching element Q14 in the ON state at all times, and maintaining the switching element Q13 in the OFF state at all times. Furthermore, in a case where currents that have been detected by the current sensors Si11 and Si12 are negative (in a case where a current flows from the switching elements Q11, Q12, Q15, and Q16 via the inductors L11 and L12 to the commercial power supply), the control unit CNT repeats an operation to turn on the switching elements Q11 and Q16, and turn off the switching elements Q12 and Q15, and then turn off the switching elements Q11 and Q16, and turn on the switching elements Q12 and Q15, while maintaining the switching element Q13 in the ON state at all times, and maintaining the switching element Q14 in the OFF state at all times. Stated another way, a power-factor improvement operation performed by the inductor L11 and the switching elements Q11, Q12, Q13, and Q14 and a power-factor improvement operation performed by the inductor L12 and the switching elements Q13, Q14, Q15, and Q16 are performed with phases shifted. By doing this, at the time of charging the battery B, AC power that has been input from the commercial power supply via the input/output terminal T1 and the input/output terminal T2 to the bidirectional inverter circuit INV1 is improved in the power factor, and is rectified, and the rectified power is smoothed by the capacitor C1, and is output to the bidirectional DCDC converter circuit CNV1.

### <Example of Control on Operation of Bidirectional Inverter Circuit INV2 at the Time of Charging Battery B>

In a case where currents that have been detected by the current sensors Si21 and Si22 are positive (in a case where a current flows from the commercial power supply via the inductors L21 and L22 to the switching elements Q21, Q22, Q25, and Q26), the control unit CNT repeats an operation to turn on the switching elements Q22 and Q25, and turn off the switching elements Q21 and Q26, and then turn off the switching elements Q22 and Q25, and turn on the switching elements Q21 and Q26, while maintaining the switching element Q24 in the ON state at all times, and maintaining the switching element Q23 in the OFF state at all times. In a case where currents that have been detected by the current sensors Si21 and Si22 are negative (in a case where a current flows from the switching elements Q21, Q22, Q25, and Q26 via the inductors L21 and L22 to the commercial power supply), the control unit CNT repeats an operation to turn on the switching elements Q21 and Q26, and turn off the switching elements Q22 and Q25, and then turn off the switching elements Q21 and Q26, and turn on the switching elements Q22 and Q25, while maintaining the switching element Q23 in the ON state at all times, and maintaining the switching element Q24 in the OFF state at all times. Stated another way, a power-factor improvement operation performed by the inductor L21 and the switching elements Q21, Q22, Q23, and Q24 and a power-factor improvement operation performed by the inductor L22 and the switching elements Q23, Q24, Q25, and Q26 are performed with phases shifted. By doing this, at the time of charging the battery B, AC power that has been input from the commercial power supply via the input/output terminal T1 and the input/output terminal T2 to the bidirectional inverter circuit INV2 is improved in the power factor, and is rectified, and the rectified power is smoothed by the capacitor C2, and is output to the bidirectional DCDC converter circuit CNV2.

### Example of Control on Operation of Bidirectional Inverter Circuit INV1 at the Time of Supplying Power in Single-Phase Three-Wire System

During a period when a positive voltage is applied to the input/output terminal T1, the control unit CNT repeatedly turns on or off the switching elements Q11 and Q15, while maintaining the switching element Q14 in the ON state at all times, and maintaining the switching elements Q12, Q13, and Q16 in the OFF state at all times, and during a period when a negative voltage is applied to the input/output terminal T1, the control unit CNT repeatedly turns on or off the switching elements Q12 and Q16, while maintaining the switching element Q13 in the ON state at all times, and maintaining the switching elements Q11, Q14, and Q15 in the OFF state at all times. Note that an arm of the switching elements Q11 and Q12 and an arm of the switching elements Q15 and Q16 may be shifted in phase. By doing this, DC power that has been input from the bidirectional DCDC converter circuit CNV1 via the capacitor C1 to the bidirectional inverter circuit INV1 is converted into AC power by the bidirectional inverter circuit INV1, and the AC power is supplied to the load Loα that is connected between the input/output terminal T1 and the neutral terminal Tn.

### <Example of Control on Operation of Bidirectional Inverter Circuit INV2 at the Time of Supplying Power in Single-Phase Three-Wire System>

During a period when a positive voltage is applied to the neutral terminal Tn, the control unit CNT repeatedly turns on or off the switching elements Q21 and Q25, while maintaining the switching element Q24 in the ON state at all times, and maintaining the switching elements Q22, Q23, and Q26 in the OFF state at all times, and during a period when a negative voltage is applied to the neutral terminal Tn, the control unit CNT repeatedly turns on or off the switching elements Q22 and Q26, while maintaining the switching element Q23 in the ON state at all times, and maintaining the switching elements Q21, Q24, and Q25 in the OFF state at all times. Note that an arm of the switching elements Q21 and Q22 and an arm of the switching elements Q25 and Q26 may be shifted in phase. By doing this, DC power that has been input from the bidirectional DCDC converter circuit CNV2 via the capacitor C2 to the bidirectional inverter circuit INV2 is converted into AC power by the bidirectional inverter circuit INV2, and the AC power is supplied to the load Loβ that is connected between the input/output terminal T2 and the neutral terminal Tn.

Note that the interleaved bidirectional inverter circuits INV1 and INV2 may be applied to the bidirectional inverter circuits INV1 and INV2 illustrated in FIG. 3, or may be applied to the bidirectional inverter circuits INV1 and INV2 illustrated in FIG. 4. Furthermore, switching elements of interleaved-connected arms have operated out of phase, as described above, but may be synchronized.

As described above, in the bidirectional charger Ch illustrated in FIG. 5, similarly to the bidirectional charger Ch illustrated in FIG. 1, the respective bidirectional inverter circuits INV included in the bidirectional power conversion circuits PC1 and PC2 are totem-pole bidirectional inverter circuits INV, the number of inductors L that are connected to the input/output terminal T1, the input/output terminal T2, and the neutral terminal Tn can be reduced, and the number of switching elements that are connected to the inductor L can also be reduced. This can reduce the number of places where a variation in a potential on a switching element side of the inductor L occurs when the switching element performs switching in the power-factor improvement operation at the time of charging. Therefore, at the time of charging the battery B, noise that occurs due to switching of the switching element Q in the bidirectional inverter circuit INV can be reduced, and noise that is input to a side of the commercial power supply can be reduced at the time of charging the battery B.

Furthermore, in the bidirectional charger Ch illustrated in FIG. 5, the respective bidirectional inverter circuits INV1 and INV2 are interleaved bidirectional inverter circuits INV, and therefore power to be supplied to the battery B at the time of charging the battery B or power to be supplied to the load Lo at the time of supplying power in the single-phase three-wire system can be increased.

Furthermore, in the bidirectional charger Ch illustrated in FIG. 5, for example, in a case where a single CPU is used as the control unit CNT to control the two bidirectional inverter circuits INV1 and INV2, a current flows through the bidirectional inverter circuits INV1 and INV2 in the same direction, and therefore the control unit CNT can easily perform control.

Furthermore, in the bidirectional charger Ch illustrated in FIG. 5, the bidirectional inverter circuits INV1 and INV2 are directly connected to each other in the neutral terminal Tn, but the connected inductors L21 and L22 are interposed, and therefore the inductors can avoid a variation in current, and resonance is not likely to occur in a current loop via respective stray capacitances of the bidirectional inverter circuits INV1 and INV2.

Furthermore, in the bidirectional charger Ch illustrated in FIG. 5, an arm constituted by the switching elements Q11 and Q12 and an arm constituted by the switching elements Q15 and Q16 are interleaved-connected to distribute an amount of a current that flows, and the switching elements Q13 and Q14 only perform switching at the time of polarity inversion, and therefore the loss of each of the switching elements can be leveled in comparison with the embodiment and the first and second variations, and an increase in the number of switching elements can be avoided.

What is claimed is:

1. A bidirectional charger comprising:
a first input/output terminal that is connected to a first load;
a second input/output terminal that is connected to a second load that is connected in series to the first load;
a neutral terminal that is connected to a connection point between the first load and the second load, and is grounded;
a first switch;
a second switch;
a first bidirectional inverter circuit that is connected to the first input/output terminal and one end of the first switch;
a second bidirectional inverter circuit that is connected to the second input/output terminal and one end of the second switch;
a first bidirectional DCDC converter circuit that converts DC power that has been supplied from the first bidirectional inverter circuit into DC power having a different voltage to output the DC power after conversion to a battery, and converts DC power that has been supplied from the battery into DC power having a different voltage to output the DC power after conversion to the first bidirectional inverter circuit;
a second bidirectional DCDC converter circuit that converts DC power that has been supplied from the second bidirectional inverter circuit into DC power having a different voltage to output the DC power after conversion to the battery, and converts DC power that has been supplied from the battery into DC power having a different voltage to output the DC power after conversion to the second bidirectional inverter circuit; and
a control unit that controls the first bidirectional inverter circuit, the second bidirectional inverter circuit, the first bidirectional DCDC converter circuit, the second bidirectional DCDC converter circuit, the first switch, and the second switch,
wherein another end of the first switch is switchably connected to the neutral terminal and the second input/output terminal,
another end of the second switch is switchably connected to the neutral terminal and the first input/output terminal,
the first bidirectional inverter circuit includes:
a first arm to which a first switching element and a second switching element are connected in series;
a second arm to which a third switching element and a fourth switching element are connected in series; and
a first coil in which one end is connected to a connection point between the first switching element and the second switching element, and another end is connected to one of the first input/output terminal and the one end of the first switch,
the first arm and the second arm are connected in parallel, and a connection point between the third switching element and the fourth switching element is connected to another of the first input/output terminal and the one end of the first switch,
the second bidirectional inverter circuit includes;
a third arm to which a fifth switching element and a sixth switching element are connected in series;
a fourth arm to which a seventh switching element and an eighth switching element are connected in series; and
a second coil in which one end is connected to a connection point between the fifth switching element and the sixth switching element, and another end is connected to one of the second input/output terminal and the one end of the second switch, and
the third arm and the fourth arm are connected in parallel, and a connection point between the seventh switching element and the eighth switching element is connected to another of the second input/output terminal and the one end of the second switch.

2. The bidirectional charger according to claim 1, wherein
the control unit performs control to cause the first coil of the first bidirectional inverter circuit to be connected to the first input/output terminal, and cause the second coil of the second bidirectional inverter circuit to be connected to the neutral terminal at a time of supplying power in a single-phase three-wire system.

3. The bidirectional charger according to claim 1, wherein
the control unit performs control to cause the first coil of the first bidirectional inverter circuit to be connected to the neutral terminal, and cause the second coil of the second bidirectional inverter circuit to be connected to the neutral terminal at a time of supplying power in a single-phase three-wire system.

4. The bidirectional charger according to claim 1, wherein
the control unit performs control to cause the first coil of the first bidirectional inverter circuit to be connected to the first input/output terminal, and cause the second coil of the second bidirectional inverter circuit to be connected to the second input/output terminal at a time of supplying power in a single-phase three-wire system.

5. The bidirectional charger according to claim 1, wherein
the first bidirectional inverter circuit includes a fifth arm and a third coil, the fifth arm being connected in parallel to the first arm and the second arm, a ninth switching element and a tenth switching element being connected in series to the fifth arm,
in the third coil, one end is connected to a connection point between the ninth switching element and the tenth switching element, and another end is connected to one of the first input/output terminal and the one end of the first switch,
the second bidirectional inverter circuit includes a sixth arm and a fourth coil, the sixth arm being connected in parallel to the third arm and the fourth arm, an eleventh switching element and a twelfth switching element being connected in series to the sixth arm, and
in the fourth coil, one end is connected to a connection point between the eleventh switching element and the twelfth switching element, and another end is connected to one of the second input/output terminal and the one end of the second switch.
